(19) United States
(12) Patent Application Publication
(10) Pub. No.: US 2026/0097619 A1
(43) Pub. Date: Apr. 9, 2026

(54) VIBRATION DAMPER FOR A MOTOR VEHICLE

(71) Applicants: thyssenkrupp Bilstein GmbH, Ennepetal (DE); thyssenkrupp AG, Essen (DE)

(72) Inventor: Lars SCHWEDLER, Arnsberg (DE)

(73) Assignees: thyssenkrupp Bilstein GmbH, Ennepetal (DE); thyssenkrupp AG, Essen (DE)

(21) Appl. No.: 19/353,385

(22) Filed: Oct. 8, 2025

(30) Foreign Application Priority Data
Oct. 9, 2024 (DE) 10 2024 129 208.3

(51) Int. Cl. B60G 15/06; B60G 13/08; B60G 17/08

(52) U.S. Cl. CPC B60G 15/06; B60G 13/08; B60G 17/08; B60G 2202/32; B60G 2204/62; B60G 2206/41; B60G 2206/73; B60G 2206/82092; B60G 2500/104; B60G 2600/21; B60G 2800/162; B60G 2800/916

(57) ABSTRACT

A vibration damper for a vehicle comprises a damper tube filled with hydraulic fluid, a working piston connected to a piston rod and arranged to move back and forth within the damper tube, wherein the interior of the damper tube is divided by the working piston into a first working chamber and a second working chamber, a pressure stop arrangement with an auxiliary piston and a pressure stop receptacle mounted inside the damper tube for receiving the auxiliary piston, wherein the additional piston is arranged to be axially movable within the pressure stop receptacle and separates a pressure stage working chamber within the pressure stop receptacle, wherein the additional piston and the piston rod are arranged so as to be movable separately from one another, and wherein a damping element is arranged between the piston rod and the additional piston for damping the contact of the piston rod with the additional piston in the pressure stage.

### CROSS REFERENCE TO RELATED APPLICATION

This application is a U.S. Non-Provisional that claims priority to German Patent Application No. DE 10 2024 129 208.3, filed Oct. 9, 2024, the entire content of which is incorporated herein by reference.

### FIELD

The present disclosure relates to a vibration damper for a motor vehicle with a pressure stop arrangement.

### BACKGROUND

DE 10 2023 105 059 A1 discloses a hydraulic vibration damper with a hydraulic pressure stop. A hydraulic pressure stop is usually used for additional damping in the pressure stage of the vibration damper. In known vibration dampers, an additional piston plunges into a pressure stop chamber, thereby generating additional damping when the piston rod moves in the pressure direction. The components that interact in pressure damping usually have to comply with very precise manufacturing tolerances in order, for example, to compensate for transverse forces on the piston rod. The manufacture of these components is therefore usually very cost-intensive. Furthermore, the installation space for a pressure stop is limited, particularly in vibration dampers with external damping valves or in single-tube vibration dampers with external gas chambers. In addition, the noise generated when the additional damping is activated in the pressure stage must be minimized to such an extent that this process is not audible to the driver of the motor vehicle.

Thus a need exists to provide a vibration damper with a pressure stop arrangement that is inexpensive to manufacture, easy to install and low-noise.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic representation of a vibration damper in a longitudinal sectional view according to an exemplary embodiment.

FIG. 2 shows a schematic representation of a detail of a vibration damper in a longitudinal sectional view according to a further exemplary embodiment.

FIG. 3 shows a schematic representation of a detail of the piston rod of the vibration damper in a perspective view according to a further exemplary embodiment.

FIG. 4ashows a schematic representation of a detail of the piston rod of the vibration damper in a longitudinal sectional view according to a further exemplary embodiment.

FIG. 4bshows a schematic representation of a detail of the piston rod of the vibration damper in a perspective view according to a further exemplary embodiment.

FIG. 5 shows a schematic representation of a detail of a vibration damper in a longitudinal section view according to a further exemplary embodiment.

FIG. 6 shows a schematic representation of an additional piston in a longitudinal sectional view according to further exemplary embodiments.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

According to a first aspect, a vibration damper for a vehicle comprises a damper tube filled with hydraulic fluid, a working piston which is connected to a piston rod and which is arranged to move back and forth within the damper tube, wherein the interior of the damper tube is divided by the working piston into a first working chamber on the piston rod side and a second working chamber on the working chamber on the opposite side of the piston rod. The vibration damper preferably also comprises a sealing assembly which seals the damper tube on the piston rod side in a fluid-tight manner. Furthermore, the vibration damper comprises a pressure stop arrangement with an additional piston and a pressure stop receptacle mounted inside the damper tube to receive the additional piston, wherein the additional piston is arranged to be axially movable inside the pressure stop receptacle and separates a pressure stage working chamber inside the pressure stop receptacle. The additional piston and the piston rod are arranged so that they can move separately from one another. The vibration damper also has a damping element, which is arranged between the piston rod and the additional piston and is designed and arranged to damp the contact of the piston rod with the additional piston in the pressure stage.

The auxiliary piston is arranged in the pressure direction of the piston rod, wherein the piston rod is preferably movable between a position in which it is spaced apart from the auxiliary piston and a position in which the piston rod lies against the auxiliary piston. In the pressure stage, the piston rod is moved in the pressure direction until it lies against the auxiliary piston and moves it in the pressure direction. The damping element between the piston rod and the additional piston reliably minimizes the noise generated by the piston rod striking the additional piston.

The vibration damper is, for example, a single-tube or multi-tube vibration damper. For example, a multi-tube vibration damper for a vehicle comprises an outer tube and an inner tube arranged coaxially thereto, wherein a compensation space for receiving hydraulic fluid is formed between the outer tube and the inner tube, and a working piston connected to a piston rod, which is arranged so that it can move back and forth inside the inner tube, wherein the interior of the inner tube is divided by the working piston into a first working chamber on the piston rod side and a second working chamber on the side away from the piston rod. The compensation chamber is preferably filled with gas, at least partially, in particular at the upper end. The outer tube preferably forms at least part of the housing of the vibration damper. The inner surface of the inner tube is preferably designed as a guide for the working piston. The working piston preferably has a valve device through which the first and second working chambers are connected to each other. In a single-tube vibration damper, no outer tube is provided. The inner tube is referred to as the damper tube and, as described above with reference to the inner tube, accommodates the piston rod and the working piston.

In a multi-tube vibration damper, the vibration damper has, in particular, a sealing assembly which is designed and arranged to seal fluidically the interior of the outer tube on the piston rod side. The piston rod end of the inner tube is preferably attached to the sealing assembly. Opposite the sealing assembly, at the end remote from the piston rod, the compensation chamber and the second working chamber are preferably sealed fluidically by means of a base piece. The compensation chamber is preferably connected to the first or second working chamber via openings in the inner tube. For example, the compensation chamber is sealed to the inner tube by means of a base element. The sealing assembly is preferably arranged coaxially with the piston rod and surrounds it circumferentially.

In a single-tube vibration damper, the vibration damper has, in particular, a sealing assembly which is designed and arranged to seal the interior of the damper tube on the piston rod side in terms of fluid technology. The piston rod end of the damper tube is preferably attached to the sealing assembly. Opposite the sealing assembly, at the end remote from the piston rod, the interior of the damper tube is preferably sealed against fluid flow by means of an axially movable sealing element. The sealing element preferably separates a gas chamber adjoining it in the axial direction from the working chamber filled with hydraulic fluid.

In the following description, the term “vibration damper” refers to both a multi-tube vibration damper and a single-tube vibration damper, wherein the damper tube is the inner tube of a multi-tube vibration damper.

The pressure stop arrangement is preferably located inside the damper tube, in particular in the end region of the damper tube remote from the piston rod, and preferably comprises the pressure stop receptacle and the auxiliary piston, which is mounted axially movably within the pressure stop receptacle and preferably lies fluid-tight with its outer peripheral surface at least partially or completely against the inner wall of the pressure stop receptacle. The additional piston is preferably not attached to the piston rod. The additional piston and the piston rod are in particular mounted so that they can move relative to each other. The pressure stop arrangement also comprises a pressure stage working chamber which is separated by the additional piston inside the damper tube, in particular the pressure stop receptacle.

In the following, movement in the tension direction is understood to mean movement in the direction of the seal assembly in the piston rod side area of the shock absorber, and movement in the pressure direction is understood to mean movement in the direction of the base piece in the area of the shock absorber remote from the piston rod.

According to a first embodiment, the damping element is attached to the piston rod or to the additional piston. Optionally, the vibration damper has two or more damping elements, wherein at least one damping element is attached to the piston rod and at least one damping element is attached to the auxiliary piston. The damping element is attached in particular to the end face of the auxiliary piston facing the piston rod or to the end face of the piston rod facing the auxiliary piston.

According to a further embodiment, the piston rod or the additional piston has a recess in which the damping element is arranged. Preferably, the piston rod has a contact surface for contact with the additional piston, wherein the contact surface is formed in particular on the end face of the piston rod facing the additional piston. The recess is formed on the contact surface of the piston rod. Preferably, the additional piston has a contact surface which faces in the direction of the piston rod and is designed to contact the piston rod, in particular the contact surface of the piston rod. The contact surface of the additional piston preferably forms the end face facing in the direction of the piston rod and preferably has the recess in which the damping element is arranged.

The additional piston preferably comprises a valve body with at least one or a plurality of axial through-bores, which are covered at least partially or completely on the piston rod side by valve discs. The valve discs are preferably preloaded in such a way that they allow flow from the pressure stage working chamber through the passage bores into the second working chamber from a certain pressure in the pressure stage working chamber. The passage bores together with the valve discs thus prevent a pressure increase in the pressure stage working chamber exceeding a certain value.

The valve body preferably has a radially outwardly facing shoulder at its piston rod end, which forms an axial contact surface for the throttle element. The throttle element is preferably attached around the outer circumference of the valve body and, in particular, is designed and arranged in such a way that it seals fluid-tight against the inner wall of the damper tube. The throttle element has, for example, a through-opening through which hydraulic fluid can flow. The auxiliary piston preferably has a plate which is arranged at the end of the auxiliary piston, in particular of the valve body, remote from the piston rod. The valve body, the valve discs and the plate are preferably connected via a connecting element, such as a screw or a rivet, for example with a washer. The plate preferably protrudes radially beyond the valve body and forms an axial contact surface for the throttle element. For example, the recess is formed in the connecting element, the valve body or the plate.

According to a further embodiment, the volume of the recess is greater than the volume of the damping element. This offers the advantage that the damping element can be completely accommodated within the recess when it strikes the additional piston or the piston rod, in particular without protruding from it. This significantly minimizes wear on the damping element. Preferably, the damping element has a volume that corresponds to approximately 50% to 95%, in particular 70% to 90%, preferably 80% of the volume of the recess. Preferably, the damping element is designed in such a way that, when the piston rod strikes the additional piston, it is elastically deformed in such a way that the piston rod at least partially lies against the additional piston with its front side. In particular, the damping element is designed such that when the piston rod strikes the additional piston, it is elastically deformed in such a way that it is completely located within the recess and does not protrude beyond the recess in the axial direction.

According to a further embodiment, the damping element is made of an elastic material. The damping element is preferably made of an elastic material such as rubber, in particular ECO black (rubber) or TEEE (thermoplastic).

According to a further embodiment, the damping element is designed and arranged in such a way that, in a first position in which the piston rod and the additional piston are spaced apart from each other, it protrudes axially from the recess and, in a second position in which the piston rod and the additional piston are in contact with each other, it is completely located within the recess. This minimizes wear on the damping element. Preferably, in the second position, the contact surfaces of the auxiliary piston and the piston rod are in contact with each other. The contact surfaces are preferably made of steel so that an audible noise is produced when the contact surfaces collide without damping.

According to a further embodiment, the damping element is circular ring-shaped, spherical, cuboid, cube-shaped, pyramid-shaped or cone-shaped.

According to a further embodiment, the damping element is fastened within the recess by means of a press fit. In particular, the damping element is fastened in the recess by means of a frictionally engaged, form-fitting and/or integrally bonded connection. A press fit offers a simple and secure means of fastening the damping element.

According to a further embodiment, the damping element has a surface with at least one or a plurality of elevations and depressions. Preferably, the end face of the damping element facing away from the recess has a plurality of elevations and depressions, which are in particular evenly spaced from each other. Preferably, the end face of the damping element is wave-shaped.

The damping element is preferably crown-shaped. In particular, the damping element is circular ring-shaped, with the end face facing away from the recess having a profile such as waves or serrations.

According to a further embodiment, the recess is cylindrical, hemispherical or circular ring-shaped.

According to a further embodiment, a return element is arranged within the damping element. The return element is, for example, a wave spring, which is preferably arranged completely within the damping element. The return element is made of metal in particular. Preferably, the return element has a contour that corresponds to the surface geometry of the front side of the damping element.

According to a further embodiment, the piston rod has a first piston rod region to which the working piston is attached and a second piston rod region which adjoins the working piston in the pressure direction and to which the damping element is attached. The piston rod optionally also comprises a second piston rod region, which is designed, for example, as an additional piston rod separate from the first piston rod region and adjoins the working piston in the axial direction, in particular in the pressure direction. The diameter of the second piston rod region preferably corresponds substantially to the diameter of the first piston rod region of the piston rod. The second piston rod region represents an axial extension of the piston rod.

The pressure stop receptacle preferably has a bypass opening formed at the piston rod end of the pressure stop receptacle. The bypass opening is preferably designed such that its flow cross-section decreases in the pressure direction. The bypass opening is preferably designed as a front-side notch in the pressure stop receptacle, wherein the area of the bypass opening decreases in the pressure direction along the pressure stop receptacle. The bypass path formed by the bypass opening has a flow cross-section that decreases when the auxiliary piston moves in the pressure direction. This increases the damping of the auxiliary piston when it moves in the pressure direction, thereby achieving progressive damping, for example. Preferably, no bypass openings are formed in the area of the pressure stop receptacle remote from the piston rod. This ensures that maximum damping is set before the auxiliary piston stops against the base piece.

Optionally, the vibration damper has an adapter mounted inside the damper tube for attaching a damping valve device or a flow passage formed in the damper tube for attaching a compensation device, wherein the additional piston is arranged between the adapter or the flow passage and the end of the damper tube remote from the piston rod.

The vibration damper also optionally has a damping valve device, which is preferably attached to the damper tube by means of the adapter. The damping valve device is preferably connected fluidically to the second working chamber, in particular the interior of the damper tube, via the adapter. The damping valve device is, for example, a solenoid valve, which is in particular continuously adjustable. Optionally, the damping valve device serves exclusively for additional damping in the pressure stage.

The adapter is preferably mounted completely inside the damper tube, in particular inside the working chamber of the damper tube remote from the piston rod, and is preferably connected to the damper tube in a fixed position. In the axial direction, the adapter is preferably arranged at a distance from the base piece. For example, the adapter is arranged and designed in such a way that it limits the movement of the additional piston in the tension direction. The adapter optionally forms an axial end stop for movement of the additional piston in the tension direction, with the tension stop in particular lying against the adapter. The adapter is, for example, sleeve-shaped and in particular forms a narrowing of the inner diameter of the damper tube.

The pressure stop receptacle is designed in particular to be sleeve-shaped. Preferably, the additional piston lies fluid-tight against the inner wall of the pressure stop receptacle, wherein the pressure stop receptacle forms a guide for the additional piston. Preferably, the additional piston and the piston rod are movable independently of each other. This allows the piston rod to move without the additional mass of the additional piston during normal operation of the shock absorber, wherein the additional piston is moved exclusively for pressure stage damping within the pressure stop chamber by the piston rod.

Optionally, a spring element is arranged between the additional piston and the end of the damper tube remote from the piston rod. The pressure stop arrangement comprises, in particular, the spring element, which preferably lies against the auxiliary piston and the damper tube end with its respective end regions. The spring element is, for example, a coil spring. Preferably, the spring element is preloaded against the auxiliary piston so that it acts on the auxiliary piston with a force in the tensile direction.

Preferably, the additional piston has a bypass channel and a throttle element for adjusting the flow cross-section of the bypass channel, wherein the throttle element is mounted so as to be movable in the axial direction. The bypass channel is formed in particular between the valve body and the throttle element. The bypass channel is provided in addition to the through bores and provides an additional flow channel when the auxiliary piston moves in the pressure or tension direction.

In particular, the bypass channel is formed at least partially by recesses in the valve body. The recesses are preferably formed in the radially outward-facing circumferential surface of the valve body. The valve body has, for example, a plurality of recesses which are arranged circumferentially, in particular, at equal distances from one another. In particular, the plate has a plurality of cut-outs. The bypass channel is preferably formed by the cut-outs in the plate, the recesses in the valve body and the throttle element.

The throttle element is preferably designed and arranged in such a way that it releases a first flow cross-section of the bypass channel in a first position and releases a second flow cross-section of the bypass channel in a second position. According to a further embodiment, the first flow cross-section is smaller than the second flow cross-section. According to a further embodiment, the throttle element is arranged such that it is moved into the first position when the auxiliary piston moves in the pressure direction and into the second position when the auxiliary piston moves in the extension direction. This enables the auxiliary piston to experience greater damping when moving in the pressure direction than when moving in the extension direction. The additional piston thus fulfils the function of a pressure stop with additional damping of the piston rod in the pressure direction.

The throttle element is preferably arranged and designed in such a way that, when the additional piston moves in the pressure direction, it lies against the shoulder of the valve body and closes the bypass channel at least partially or completely. Preferably, the bypass channel comprises a first flow cross-section which corresponds, for example, to the cross-section of the through-opening in the throttle element. The throttle element is preferably arranged and designed in such a way that, when the additional piston moves in the tension direction, it lies against a shoulder remote from the piston rod, in particular against the plate, and releases the bypass channel, in particular the second flow channel.

For example, the throttle element is designed to be ring-shaped. The throttle element, which is designed as a piston ring, has, for example, a through-opening designed as a slot, which forms a complete circumferential interruption of the ring-shaped piston ring.

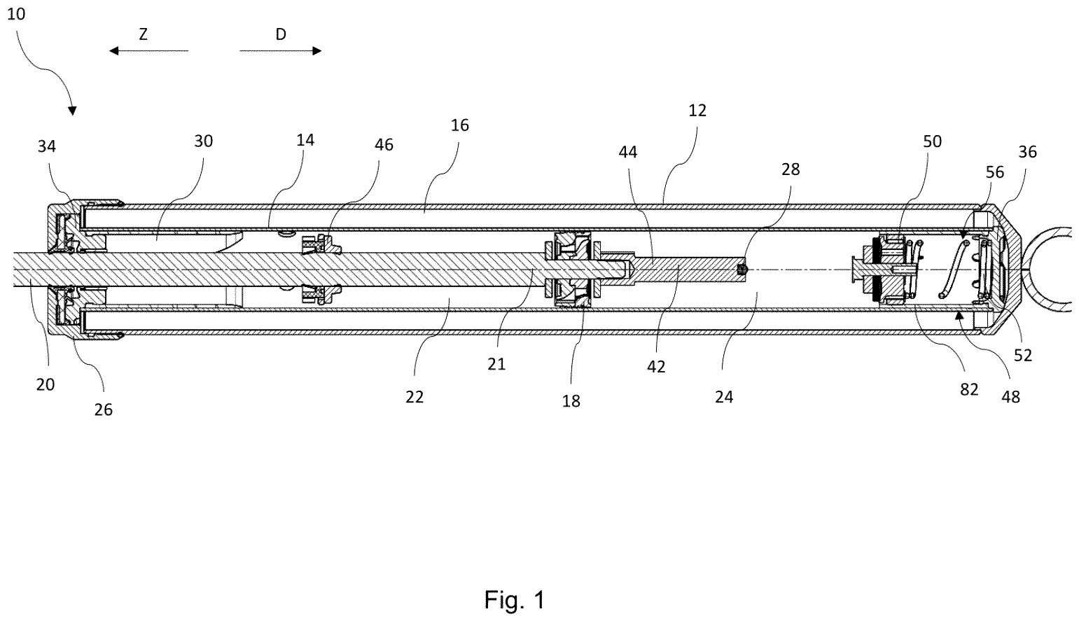

FIG. 1 shows a vibration damper 10, wherein the vibration damper 10 is, for example, a multi-tube vibration damper, for example a two-tube vibration damper. The vibration damper 10 has an outer tube 12 which forms an outer surface, in particular a housing, of the vibration damper 10. Inside the outer tube 12, a damper tube 14 is arranged coaxially with the latter, which is also referred to as an inner tube 14. A compensation chamber 16 is formed between the outer tube 12 and the inner tube 14 and is preferably filled at least partially or completely with a hydraulic fluid. For example, the compensation chamber 16 is partially filled with a gas.

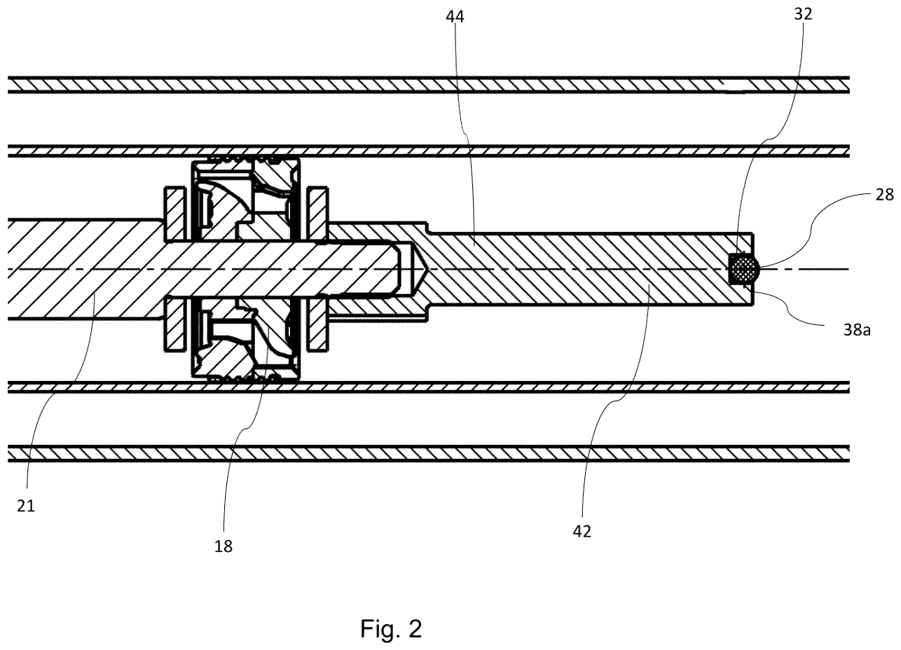

A working piston 18 connected to a piston rod 20 is arranged inside the inner tube 14 in such a way that it can move inside the inner tube 14, wherein the inner tube preferably is designed as a guide for the working piston 18. The working piston 18 preferably has a valve device. For example, the valve device comprises a tension stage valve for damping the piston movement in the tension stage and a pressure stage valve for damping the piston movement in the pressure stage. Preferably, the valves are each formed by a through-opening through the piston and a valve disc assembly. The working piston 18 divides the interior of the inner tube 14 into a first working chamber 22, which is located on the piston rod side, and a second working chamber 24, which is located away from the piston rod. The piston rod 20 can preferably be connected to the vehicle body with its end protruding from the damper tube 14. The piston rod 20 has, for example, a first piston rod region 21 which extends to the working piston 18 and to which the working piston 18 is attached. The working piston 18 is preferably attached to the end region of the first piston rod region 21 opposite the end of the piston rod 20 protruding from the damper tube 14. The piston rod 20 comprises, for example, a second piston rod region 44, in particular an additional piston rod 42, which is connected to the working piston 18 in the axial direction, in particular in the pressure direction D. The additional piston rod 42 preferably forms an axial extension of the piston rod 20, in particular of the first piston rod region 21. The diameter of the additional piston rod 42 preferably corresponds substantially to the diameter of the first piston rod region 21 of the piston rod 20. For example, the additional piston rod 42 has two different diameters. In a first piston rod-side region, the additional piston rod 42 has, for example, a first diameter which corresponds to the diameter of the piston rod 20. In a second region of the additional piston rod 42 facing away from the piston rod, the additional piston rod 42 has, in particular, a second diameter that is smaller than the first diameter. The second piston rod region 44 preferably has an axial length that is greater than the axial length of an adapter (not shown) for attaching a damping valve device. It is also included that the vibration damper 10 does not have a separate additional piston rod 42. In this case, the piston rod 20 has an extension compared to the piston rod 20 of FIGS. 1 and 2. The piston rod 20 extends beyond the working piston 18 in the pressure direction D. Preferably, the extension is the region of the piston rod 20 that extends beyond the working piston 18 in the pressure direction D. The extension is preferably formed integrally and/or in one piece with the piston rod 20.

The interior of the outer tube 12 is sealed on the piston rod side by means of a sealing assembly 34. Opposite the sealing assembly 34, at the end remote from the piston rod, the compensation chamber 16 is sealed by means of a base piece 36. The interior of the damper tube 14, in particular the second working chamber 24, is preferably also sealed against fluids by means of the base piece 36. It is also conceivable that a further base element is provided separately from the base piece, which seals the outer tube. Preferably, the vibration damper 10 does not have a base valve. The piston rod end of the inner tube 14 is preferably attached to the closure assembly 34.

The outer tube 12 is preferably cylindrical in shape and optionally has a smaller diameter at the piston rod end region, which is at least partially enclosed by a cap 26. The cap 26 forms an end piece of the outer tube 12 and at least partially encloses the closure assembly 34.

The vibration damper 10 comprises, for example, a tension stop 46 which is fixedly attached to the piston rod 20. The tension stop 46 is, for example, ring-shaped and arranged between the working piston 18 and the closure assembly 34 within the first working chamber 22. Preferably, the tension stop 46, in particular the end face pointing in the direction of the closure assembly 34, forms a stop surface for contact with the closure assembly 34 when the piston rod moves in the tension direction Z. The tension stop 46 serves to limit the movement of the piston rod in the tension direction Z. The vibration damper 10 by way of example comprises a tension stop sleeve 30 which is mounted coaxially with the damper tube 14 and at the end of the damper tube 14 on the closure assembly side. Preferably, the outer surface of the tension stop sleeve 30 lies against the inner surface of the damper tube 14. The tension stop sleeve 30 is preferably designed for axial guidance of the tension stop in the tension stage. Optionally, the vibration damper 10 does not have a tension stop sleeve 30, wherein a flow gap is formed between the tension stop 46 and the inner wall of the damper tube 14, through which the hydraulic fluid can flow during piston rod movement.

The vibration damper 10 optionally comprises two or exactly one damping valve device, not shown in the figures, for damping the piston rod movement in the tension stage and in the pressure stage. The direction of movement of the piston rod 20 in the pressure stage D and in the tension stage Z is illustrated in FIG. 1 by the arrows Z and D. The damping valve device is connected fluidically to the second working chamber 24, in particular the interior of the damper tube 14, via the sleeve-shaped adapter, which is not shown. The damping valve device is, for example, a solenoid control valve, which is in particular continuously adjustable. Optionally, the damping valve device serves exclusively for additional damping in the pressure stage.

The vibration damper 10 comprises, for example, a pressure stop arrangement 48 which is arranged inside the damper tube 14, in particular in the end region of the damper tube 14 remote from the piston rod. The pressure stop arrangement 48 preferably comprises a pressure stop receptacle 82 and an additional piston 50, which is mounted axially movably within the pressure stop receptacle 82 and preferably lies fluid-tight with its outer circumferential surface at least partially or completely against the inner wall of the pressure stop receptacle 82. Preferably, the additional piston 50 is mounted within the pressure stop receptacle 82 in such a way that it can move axially, with the pressure stop receptacle 82 forming a guide for the additional piston 50. The additional piston 50 is not attached to the piston rod 20 or the additional piston rod 42, for example. The pressure stop arrangement 48 also comprises, in particular, a spring element 52, which is preferably arranged between the additional piston 50 and the base piece 36 and lies against these with its respective end regions. The spring element 52 is, for example, a coil spring. The additional piston 50 separates, in particular, a pressure stage working chamber 56 within the pressure stop receptacle 82. The pressure stage working chamber 56 is preferably arranged completely within the pressure stop receptacle 82. The pressure stop receptacle 82 is, for example, sleeve-shaped and is attached in a fluid-tight manner to the base piece 36, in particular with its end remote from the piston rod. Preferably, the pressure stop receptacle 82 lies in a fluid-tight manner with its outer diameter against the inner wall of the damper tube 14.

In the relaxed or slightly preloaded state, the spring element 52 lies against the additional piston 50 and the base piece 36.

During operation of the shock absorber 10 and when the piston rod 20 moves in the pressure direction D, the additional piston rod 42 is moved in the axial direction towards the additional piston 50 and presses the additional piston 50 in the pressure direction D towards the base piece 36, wherein the spring element 52 is tensioned. When the piston rod 20 subsequently moves in the tension direction Z, the additional piston is pressed in the tension direction Z by means of the spring element 52 until it reaches its starting position.

The vibration damper 10 also has a damping element 28 which is arranged and designed in such a way that, in the pressure stage, it damps the impact of the piston rod 20, in particular the auxiliary piston rod 42, on the auxiliary piston 50. The damping element 28 is preferably made of an elastic material, such as rubber, in particular ECO black (rubber) or TEEE (thermoplastic). The damping element 28 is exemplarily spherical in shape. It is also conceivable that the damping element 28 is cuboid, cube-shaped, pyramid-shaped or cone-shaped. Other geometric shapes with an angular or round cross-section are also possible.

Preferably, the piston rod 20, in particular the additional piston rod 42, has a contact surface 38a for contact with the additional piston 50, wherein the contact surface 38a is formed in particular on the end face of the piston rod 20 facing the additional piston 50. The piston rod 20, in particular the additional piston rod 42, has a recess 32 on the contact surface 38a, in which the damping element 28 is arranged. The damping element 28 is preferably fastened within the recess, preferably in a form-fitting, frictionally engaged and/or integrally bonded manner. In particular, the damping element 28 is pressed into the recess 32. For example, the recess 32 extends axially in the direction of the main piston 18 relative to the contact surface 38a.

Preferably, the volume of the recess 32 is greater than the volume of the damping element 28. Preferably, the damping element 28 has a volume corresponding to approximately 50% to 95%, in particular 70% to 90%, preferably 80% of the volume of the recess 32. Preferably, the damping element 28 is designed such that, when the piston rod 20 strikes the auxiliary piston 50, it is elastically deformed in such a way that the piston rod 20 at least partially lies against the auxiliary piston 50 with its front side. In particular, the damping element 28 is designed such that, when the piston rod 20 strikes the additional piston 50, it is elastically deformed in such a way that it is completely located within the recess 32 and does not protrude beyond the recess 32 in the axial direction. Preferably, the damping element 28 is designed and arranged in such a way that, in a first position in which the piston rod 20 and the additional piston 50 are spaced apart from each other, it protrudes axially from the recess 32 and, in a second position in which the piston rod 20 and the additional piston 50 are in contact with each other, it is arranged completely within the recess 32.

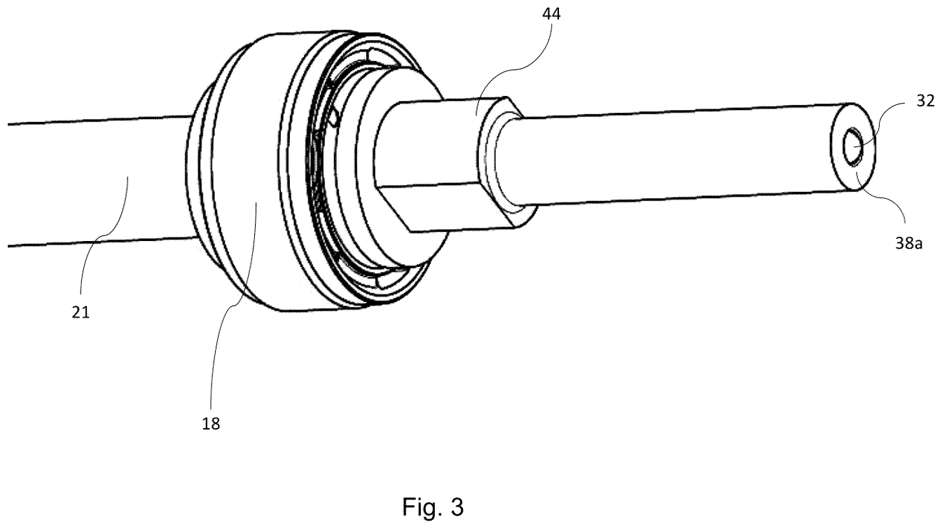

FIG. 2 shows a detail of a shock absorber 10 according to FIG. 1 in an enlarged detailed view, wherein FIG. 2 shows the vibration damper 10 in a position in which the piston rod 20 does not lie against the auxiliary piston 50. The key elements of FIG. 2 correspond to those of FIG. 1. FIG. 3 shows a detailed view of an exemplary embodiment of the piston rod 20, wherein the recess 32 is, by way of example, formed in a cylindrical shape.

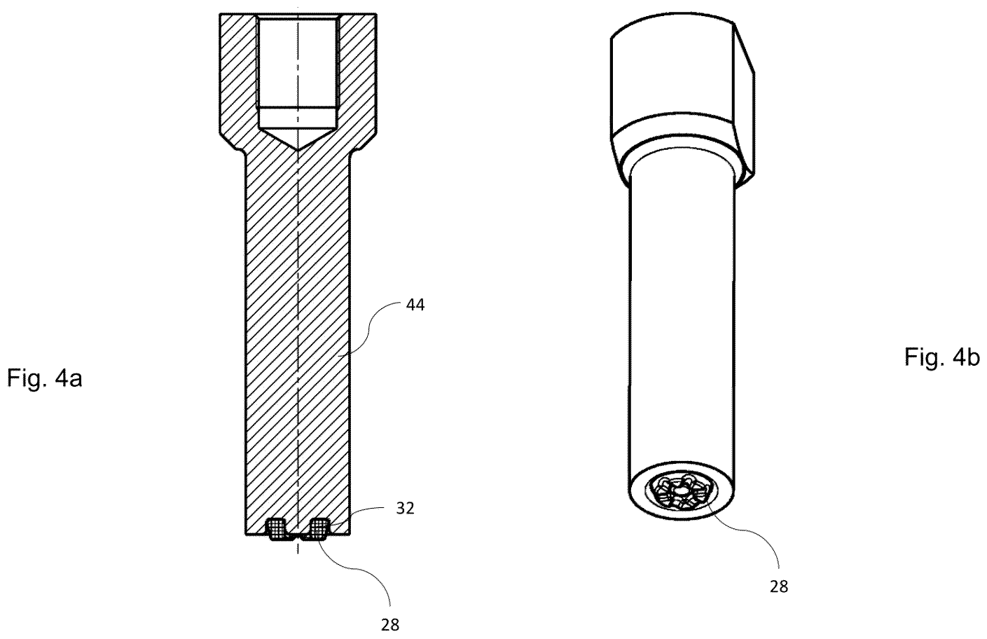

FIG. 4a and b show a further exemplary embodiment of a damping element 28, wherein the components of the vibration damper 10 substantially correspond to those of FIGS. 1 to 3. The damping element 28 in FIG. 4a and b is, by way of example, crown-shaped. Optionally, the damping element 28 has a surface facing in the direction of the auxiliary piston 50, which has at least one or a plurality of elevations and depressions. For example, the surface is designed to be wave-shaped. For example, the damping element 28 is designed to be circular, with the surface facing the auxiliary piston 50 being wave-shaped. The recess 32 is also designed to be circular. Optionally, the damping element 28 has a return element, such as a wave spring, which is arranged completely within the damping element 28.

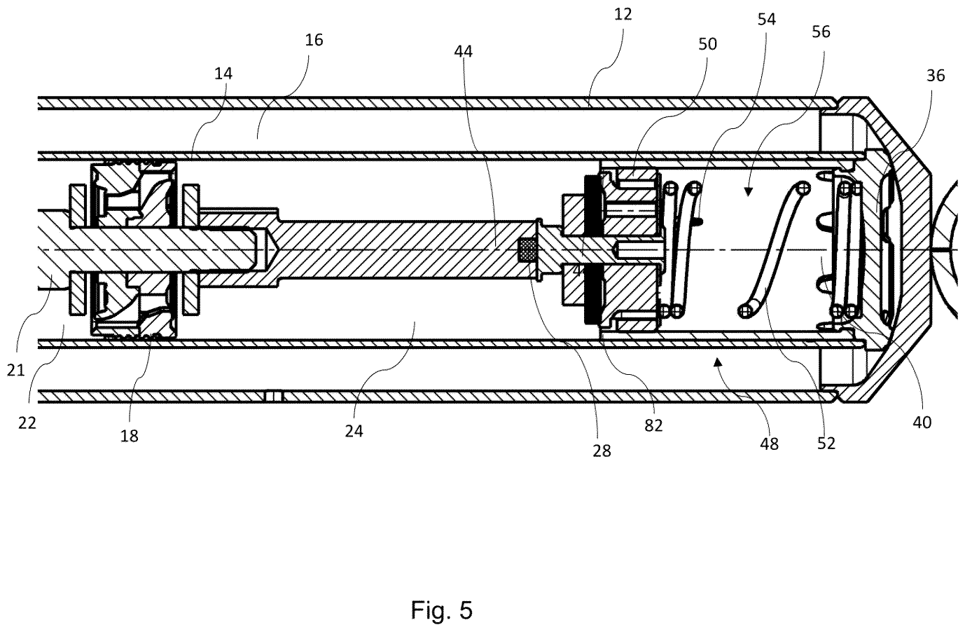

In the position shown in FIG. 5, the piston rod 20 is moved further in the pressure direction D, wherein the additional piston 50 lies against the contact surface 38a of the piston rod 20 and is preferably moved with the piston rod 20 in the pressure direction D, wherein the spring element 52 is tensioned so that it acts on the additional piston 50 in the tension direction Z with a force that preferably increases during movement in the pressure direction D. In the position shown in FIG. 5, the damping element 28 is, by way of example, arranged completely within the recess 32, wherein the contact surface 38a lies against the additional piston 50.

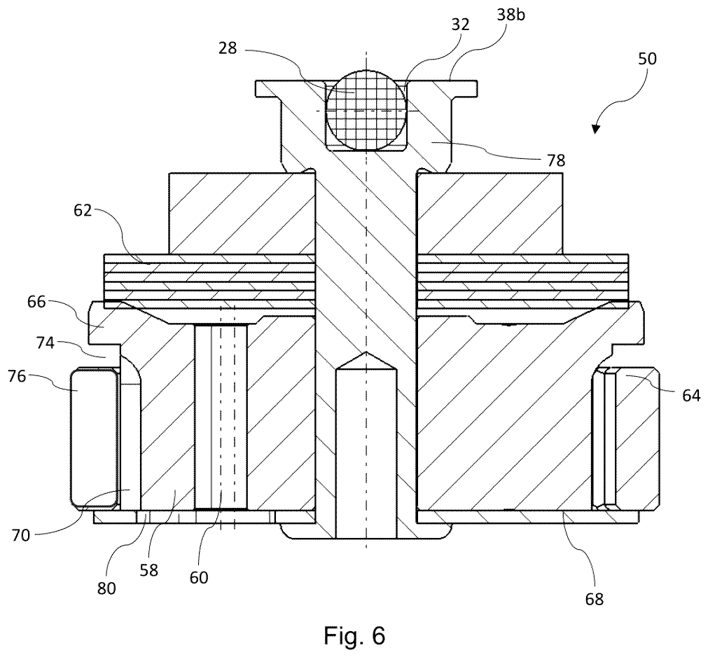

FIG. 6 shows an additional piston 50 in detail. The additional piston 50 comprises a valve body 58 with at least one or a plurality of axial through-bores 60, which are covered by valve discs 62. The valve discs 62 are attached to the piston rod end of the valve body 58 and are preloaded in such a way that they allow flow from the pressure stage working chamber 56 through the passage bores 60 into the second working chamber 24 from a certain pressure in the pressure stage working chamber 56. The passage bores 60 together with the valve discs 62 thus prevent the pressure in the pressure stage working chamber 56 from rising above a certain value.

The additional piston 50 comprises, for example, a piston ring 64 which is arranged circumferentially around the valve body 58 and is, in particular, axially movable. The piston ring 64 is, for example, circular or cylindrical in shape. The valve body 58 has, for example, a radially outwardly facing shoulder 66 at its piston rod end, which forms an axial contact surface for the piston ring 64. The piston ring 64 is designed in such a way that it seals fluid-tight against the inner wall of the damper tube 14. The piston ring 64 has, for example, a through-opening 76 through which hydraulic fluid can flow. The auxiliary piston 50 preferably has a plate 68 which is arranged at the end of the auxiliary piston 50 remote from the piston rod, in particular at the valve body 58. The plate 68 preferably protrudes radially beyond the valve body 58 and forms an axial contact surface for the piston ring 64. The valve body 58, the valve discs 62, and the plate 68 are preferably connected by a connecting element 78, such as a screw or a rivet, for example with a washer.

The piston ring 64 is preferably arranged around the valve body 58 in such a way that it can be moved axially, in particular continuously, from a first position, in which it lies against the shoulder 66 of the valve body 58, to a second position, in which it lies against the plate 68. The valve body 58 preferably has recesses 70 on its outer surface, which are preferably arranged in alignment with cut-outs 80 in the plate 68, so that a bypass channel 74 is formed between the pressure stage working chamber 56 and the working chamber 24 remote from the piston rod.

When the auxiliary piston 50 moves in the pressure direction D, the piston ring 64 lies against the shoulder 66 of the valve body 58 and closes the bypass channel 74 at least partially. The bypass channel 74 then comprises a first flow cross-section, which corresponds, for example, to the cross-section of the through-opening 76 in the piston ring 64. FIG. 6 shows a position of the piston ring 64 when the auxiliary piston 50 moves in the tension direction Z, wherein the piston ring 64 lies against the plate 68 and preferably opens the bypass channel 74. In the position of the piston ring 64 shown in FIG. 6, the bypass channel 74 has a second flow cross-section that is larger than the first flow cross-section. The piston ring 64 preferably serves as a throttle element for throttling the flow cross-section of the bypass channel 74.

The recesses 70 are preferably formed in the radially outward-facing circumferential surface of the valve body 58. The valve body 58 has, for example, a plurality of recesses 70 which are arranged circumferentially at equal distances from one another. The recesses 70 preferably extend in the axial direction from the end of the valve body 58 remote from the piston rod to the shoulder 66 of the valve body 58. For example, the recesses 70 are formed in a half-shell shape with a semicircular cross-section. The recesses preferably have a round, partial circular or angular cross-section. In particular, the recesses 70 are all identical in design.

The plate 68 preferably has a plurality of cut-outs 80 through which the hydraulic fluid can flow. The cut-outs 80 are preferably arranged in alignment with the recesses 70. In particular, at least some of the cut-outs 80 are arranged in alignment with the through-bores 60. The bypass channel 74 is preferably formed by the cut-outs 80 in the plate 68, the recesses 70 in the valve body 58 and the piston ring 64. The plate 68 is rotatable, for example, about the axial centre axis of the auxiliary piston 50, so that the alignment of the cut-outs 80 relative to the through-bores 60 and the recesses 70 is adjustable and thus the flow cross-section can be varied.

The piston ring 64 has, for example, a through-opening 76 designed as a slot, which represents a complete circumferential interruption of the annular piston ring 64. For example, the piston ring 64 has a plurality, in particular three, through-openings 76. Opposite through-openings 76 are preferably identical in design. For example, the through-opening 76 is designed as a recess in the inner wall and/or the piston rod-side end face of the piston ring 64.

For example, the auxiliary piston 50 has a damping element 28. Preferably, either the auxiliary piston 50 or the piston rod 20 has the damping element 28. The damping element 28 is attached in particular to the end face of the auxiliary piston 50 facing in the direction of the piston rod 20. Preferably, the additional piston has a contact surface 38b which faces in the direction of the piston rod 20 and is designed to contact the piston rod 20, in particular the contact surface 38a of the piston rod 20. The contact surface 38b preferably forms the end face facing in the direction of the piston rod 20 and preferably has a recess 32 in which the damping element 28 is arranged. The recess 32 is formed, for example, in the connecting element 78. The damping element 28 and the recess 32 correspond to the embodiments described with reference to the recess 32 and the damping element 28 of the piston rod 20.

The pressure stop receptacle 82 shown in FIGS. 1 and 5 is, by way of example, cylindrical in shape and has a bypass opening 54 which extends through the wall of the pressure stop receptacle 82 and forms a further bypass for hydraulic fluid between the auxiliary piston 50 and the inner wall of the damper tube 14. The bypass opening 54 extends, for example, from the piston rod end of the pressure stop receptacle 82 to approximately the axial centre of the pressure stop receptacle 82. For example, the bypass opening 54 is designed to taper in the pressure direction, so that the flow cross-section of the bypass opening 54 decreases in the pressure direction. For example, the pressure stop receptacle 82 has two bypass openings 54, which are in particular identical in design. Preferably, the bypass openings 54 are arranged opposite each other, in particular offset by 180° in circumference. The bypass opening 54 forms a further bypass path through which hydraulic fluid flows from the pressure stage working chamber 56 between the auxiliary piston 50 and the inner wall of the damper tube 14. The configuration of the bypass opening 54, which runs in the pressure direction D, ensures, for example, progressive damping of the additional piston in the pressure direction, since the flow cross-section of the bypass path is reduced when the additional piston 50 moves in the pressure direction D.

The pressure stop receptacle 82 comprises, for example, a plurality of connecting arms 40, which are formed at the end region of the pressure stop receptacle 82 remote from the piston rod and point in the axial direction. The connecting arms 40 are designed in such a way that they form a form-fit connection, in particular a snap-in connection, with the base piece 36. Preferably, the pressure stop receptacle 82 has a plurality of connecting arms 40, in particular identically designed connecting arms 40, which are arranged at equal distances from each other, in particular circumferentially. The connecting arms 40 are, for example, reversibly deformable in the radial direction outwards, so that the inner diameter of the pressure stop receptacle 82 can be increased. In particular, the connecting arms 40 have a radially inwardly pointing shoulder at their ends remote from the piston rod. To connect the pressure stop receptacle 82 to the base piece 36, it is pushed onto the base piece 36, wherein the connecting arms 40 are reversibly deformed and form a form-fit connection, in particular a snap lock, with a region in the base piece 36 that is preferably complementary to the connecting arms 40.

### LIST OF REFERENCE SIGNS

10 vibration damper
12 outer tube
14 damper tube/inner tube
16 compensation chamber
18 working piston
20 piston rod
21 first piston rod region
22 first working chamber
24 second working chamber
26 cap
28 damping element
30 tension stop sleeve
32 recess
34 closure assembly
36 base piece
38a contact surface
38b contact surface
40 connecting arms
42 additional piston rod
44 second piston rod region
46 tension stop
48 pressure stop arrangement
50 additional piston
52 spring element
54 bypass opening in the pressure stop receptacle
56 pressure stage working chamber
58 valve body
60 through-bores
62 valve discs
64 piston ring
66 shoulder
68 plate
70 recesses
74 bypass channel
76 through-opening
78 connecting element
80 cut-outs
82 pressure stop receptacle
Z tension direction
D pressure direction

1. A vibration damper for a vehicle, comprising:
a damper tube filled with hydraulic fluid;
a working piston connected to a piston rod and arranged to move back and forth within the damper tube, wherein the interior of the damper tube is divided by the working piston into a first working chamber and a second working chamber;
a pressure stop arrangement with an additional piston; and
a pressure stop receptacle mounted inside the damper tube to receive the auxiliary piston;
wherein the additional piston is arranged to be axially movable within the pressure stop receptacle and separates a pressure stage working chamber within the pressure stop receptacle;
wherein the additional piston and the piston rod are arranged to be movable separately from each other;
wherein a damping element is arranged between the piston rod and the additional piston for damping the contact of the piston rod with the additional piston in the pressure stage.

2. The vibration damper according to claim 1, wherein the damping element is attached to the piston rod or to the auxiliary piston.

3. The vibration damper according to claim 1, wherein the piston rod or the auxiliary piston has a recess in which the damping element is arranged.

4. The vibration damper according to claim 3, wherein the volume of the recess is greater than the volume of the damping element.

5. The vibration damper according to claim 3, wherein the damping element is designed and arranged such that, in a first position in which the piston rod and the auxiliary piston are spaced apart from each other, it protrudes axially from the recess and, in a second position in which the piston rod and the auxiliary piston are in contact with each other, it is arranged completely within the recess.

6. The vibration damper according to claim 3, wherein the damping element is secured within the recess by a press fit.

7. The vibration damper according to claim 1, wherein the damping element is made of an elastic material.

8. The vibration damper according to claim 1, wherein the damping element is designed to be circular, spherical, cuboid, cube-shaped, pyramid-shaped, cylindrical or conical.

9. The vibration damper according to claim 1, wherein the damping element has a surface with at least one or a plurality of elevations and depressions.

10. The vibration damper according to claim 1, wherein the recess is cylindrical, hemispherical or circular ring-shaped.

11. The vibration damper according to claim 1, wherein a return element is arranged within the damping element.

12. The vibration damper according to claim 1, wherein the piston rod has a first piston rod region to which the working piston is attached, and a second piston rod region which adjoins the working piston in the pressure direction and to which the damping element is attached.
